(19) United States
(12) Patent Application Publication
(10) Pub. No.: US 2012/0235959 A1
(43) Pub. Date: Sep. 20, 2012

(54) SEAL ANCHOR STRUCTURES

(75) Inventor: Denis Endisch, Cupertino, CA (US)

(73) Assignee: QUALCOMM MEMS TECHNOLOGIES, INC., San Diego, CA (US)

(21) Appl. No.: 13/149,677

(22) Filed: May 31, 2011

Related U.S. Application Data
(60) Provisional application No. 61/453,080, filed on Mar. 15, 2011.

(51) Int. Cl. G09G 5/00; H01J 9/26; H02N 11/00

(52) U.S. Cl. 345/204; 310/300; 445/25

(57) ABSTRACT

This disclosure provides systems, methods and apparatus for forming raised anchor structures in a seal area. In one aspect, the anchor structures include a receiving space. Sealant can flow into the receiving spaces. In one aspect the receiving space is formed by an overhang section. In one aspect, the overhang can be formed in part by removing a sacrificial layer. The raised anchor structures in the seal area can improve adhesion between two plates by acting as mechanical hooks, further securing the plates together.

### CROSS-REFERENCE TO RELATED APPLICATIONS

This disclosure claims priority to U.S. Provisional Patent Application No. 61/453,080, filed Mar. 15, 2011, entitled “Seal Anchor Structures,” and assigned to the assignee hereof. The disclosure of the prior application is considered part of, and is incorporated by reference in, this disclosure.

### TECHNICAL FIELD

This disclosure relates to electromechanical systems and display devices. More particularly, this disclosure relates to structures that increase seal strength in electromechanical systems and display packaging.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Electromechanical systems devices and displays, such as IMOD displays, are often formed on a substrate or array glass and packaged by sealing a backplate or cover glass to the substrate. The array glass and cover glass are often secured together with a sealant, such as epoxy glue. Poor seal adhesion between the array glass and cover glass can cause the electromechanical systems device to fail.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electronic device. The electronic device can include a substrate having an array of electromechanical devices. The substrate can also include a plurality of raised anchor structures positioned in a seal area of the substrate. The device includes a backplate and a sealant disposed in the seal area between the substrate and the backplate. In one aspect, the raised anchor structures can include at least one receiving space configured to receive the sealant, which, in one aspect may be formed by an overhang.

In one aspect, the electronic device can include a routing layer and the raised anchor structures are built over the routing layer. In one aspect, the raised anchor structures include a truncated cone having at top surface including at least one depression. In one aspect, the raised anchor structures can include a base, a post disposed over the base, and a cap disposed over the post.

In one aspect, the electronic device can include a display, a processor configured to communicate with the display and to process image data, and a memory device that is configured to communicate with the processor. In one aspect, the electronic device may further include, a driver circuit configured to send at least one signal to the display. In one aspect, the electronic device can include a controller configured to send at least a portion of the image data to the driver circuit. In one aspect, the electronic device can include an image source module configured to send the image data to the processor. In one aspect, the image source module can include at least one of a receiver, transceiver, and transmitter. In one aspect, the electronic can include an input device configured to receive input data and to communicate the input data to the processor.

Another innovative aspect of the subject matter described in this disclosure can be implemented in a display package. The display package can include a substrate having an array of electromechanical devices. The substrate can also include an anchoring means formed on the substrate and circumscribing the array. The display package can further include a backplate and a sealant disposed between the substrate and the backplate. In one aspect, the anchoring means includes a raised post and cap structure, which, in one aspect includes at least one overhang. In one aspect, the anchoring means can be configured to receive epoxy below an overhang.

Another innovative aspect of the subject matter described in this disclosure can be implemented in a method of fabricating an electromechanical systems device. The method can include providing a substrate and a backplate, forming an array of electromechanical systems devices on the substrate, forming a plurality of raised anchor structures on the substrate in a seal area circumscribing the array of electromechanical systems devices, and sealing the substrate to the backplate in the seal area. In one aspect, an overhang can be formed by removing a sacrificial layer. In one aspect, the raised anchor structures can be formed during the same process as forming the array of electromechanical devices. In one aspect, the substrate can be hermetically sealed to the backplate.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 is an example of a schematic partial cross-section illustrating an implementation of the structure of the driving circuit and the associated display element of FIG. 2.

FIG. 4 is an example of a schematic exploded partial perspective view of an optical MEMS display device having an interferometric modulator array and a backplate with embedded circuitry.

FIG. 5 shows an example of a cross-section of an electromechanical display package.

FIG. 6A is an example of a schematic exploded perspective view of an electromechanical display package having raised anchor structures.

FIG. 6B is an example of a cross-sectional view of an electromechanical display package having raised anchor structures.

FIGS. 7A and 7B show example top views of optical MEMS display device having raised anchor structures.

FIG. 8 is an example of a perspective view of a raised anchor structure.

FIGS. 9A-9F show examples of cross-section schematic illustrations of various stages in a method of making raised anchor structures in a seal area.

FIGS. 10A and 10B show examples of partial cut away perspective views of raised anchor structures.

FIGS. 11A-11F show examples of cross-section schematic illustrations of raised anchor structures.

FIG. 12 shows an example process of manufacturing an electromechanical systems device package with raised anchor structures.

FIGS. 13A and 13B show examples of system block diagrams illustrating a display device that includes a plurality of interferometric modulators.

FIG. 14 is an example of a schematic exploded perspective view of an electronic device having an optical MEMS display.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Some implementations relate to a system or method to increase the adhesion properties of a substrate and a backplate in an electromechanical device. In some implementations, raised anchoring structures are formed on the substrate in sealant areas. The raised anchor structures can include a receiving space that is configured to receive sealant and thereby provide an additional sealing force to hold the substrate securely to the backplate. In some implementations, the receiving space can be in the form of an overhang or wing structure. The receiving space can then act as a hook or anchor allowing adhesive in the sealant to flow under the overhang, thus increasing the seal strength and further securing the substrate and backplate together.

Particular implementations of the subject matter described in this disclosure can be implemented to realize one or more of the following potential advantages. Some implementations can significantly improve the strength of the secured connection between the substrate and the backplate. In some implementations a mechanical connection between the substrate and the backplate can help compensate for poor adhesion between the sealant-substrate interfaces, thus increasing overall seal strength. In some implementations the process to form anchor structures can be cost effective because the anchor structures can be formed using existing layers and materials that are used to form electromechanical systems devices. In some implementations, the seal anchor structures can disrupt crack propagation in the sealant. In some implementations, the anchor structures can improve adhesion and mechanical integrity between two surfaces even if not required to completely seal the space between the surfaces.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

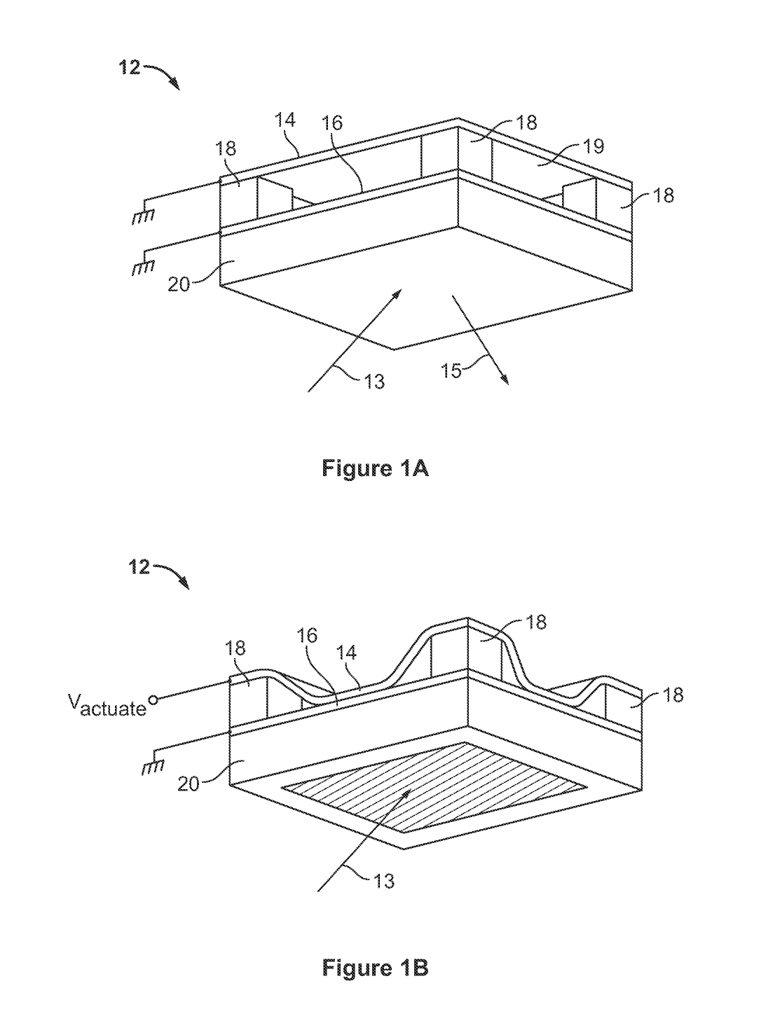

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 in FIG. 1A, a movable reflective layer 14 is illustrated in a relaxed position at a predetermined (e.g., designed) distance from an optical stack 16, which includes a partially reflective layer. Since no voltage is applied across the IMOD 12 in FIG. 1A, the movable reflective layer 14 remained in a relaxed or unactuated state. In the IMOD 12 in FIG. 1B, the movable reflective layer 14 is illustrated in an actuated position and adjacent, or nearly adjacent, to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the optical stack 16, or lower electrode, is grounded at each pixel. In some implementations, this may be accomplished by depositing a continuous optical stack 16 onto the substrate 20 and grounding at least a portion of the continuous optical stack 16 at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

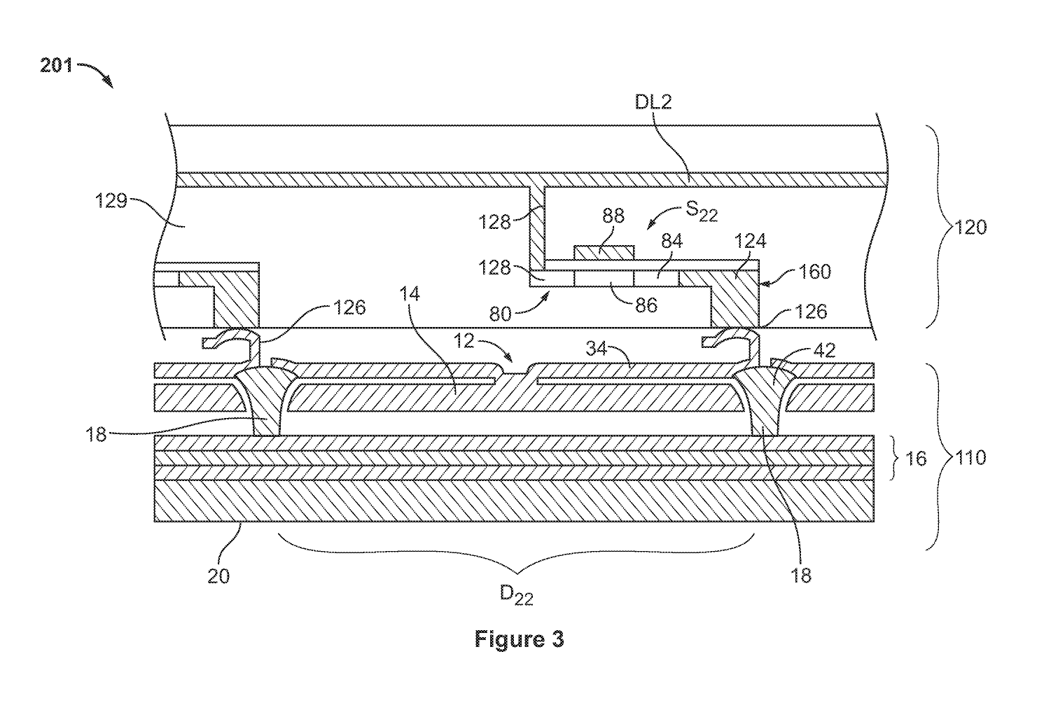

The details of the structure of interferometric modulators that operate in accordance with the principles set forth above may vary widely. For example, the movable reflective layers 14 of each IMOD 12 may be attached to supports at the corners only, e.g., on tethers. As shown in FIG. 3, a flat, relatively rigid movable reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the movable reflective layer 14 can be optimized with respect to the optical properties, and the structural design and materials used for the deformable layer 34 can be optimized with respect to desired mechanical properties. For example, the movable reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

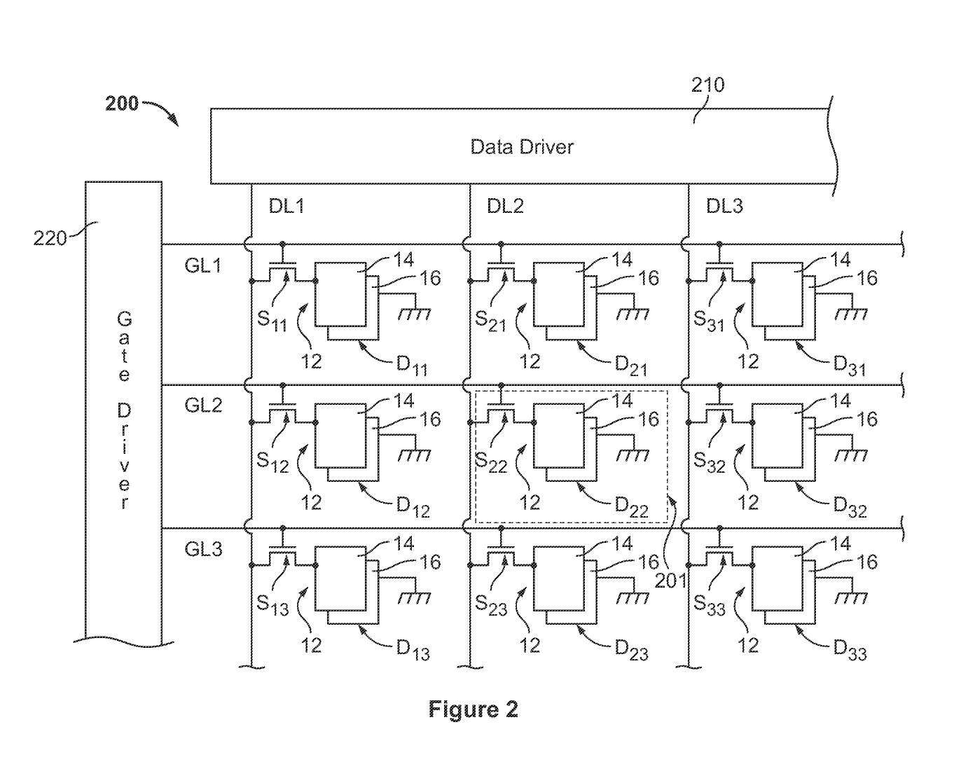

FIG. 2 shows an example of a schematic circuit diagram illustrating a driving circuit array 200 for an optical MEMS display device. The driving circuit array 200 can be used for implementing an active matrix addressing scheme for providing image data to display elements D₁₁-Dₘₘ of a display array assembly.

The driving circuit array 200 includes a data driver 210, a gate driver 220, first to m-th data lines DL1-DLm, first to n-th gate lines GL1-GLn, and an array of switches or switching circuits S₁₁-Sₘₙ. Each of the data lines DL1-DLm extends from the data driver 210, and is electrically connected to a respective column of switches S₁₁-S₁ₙ, S₂₁-S₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, . . . , D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙ-Sₘₙ in the selected row are turned on, the image data from the data driver 210 is passed to the selected row of display elements D₁₁-Dₘ₁, D₁₂-Dₘ₂, . . . , D₁ₙ-Dₘₙ.

During operation, the gate driver 220 can provide a voltage signal via one of the gate lines GL1-GLn to the gates of the switches S₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to an actuation voltage, for example 10 volts (could be positive or negative), and data lines DL that are associated with pixels that are to be released in the row can be set to a release voltage, such as 0 volts. Then, the gate line GL for the given row is asserted, turning the switches in that row on, and applying the selected data line voltage to each pixel of that row. This charges and actuates the pixels that have 10-volts applied, and discharges and releases the pixels that have O-volts applied. Then, the switches S₁₁-Sₘₙ can be turned off. The display elements D₁₁-Dₘ₁, D₁₂-Dₘ₂, . . . , D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the optical stack 16 is grounded at each pixel. In some implementations, this may be accomplished by depositing a continuous optical stack 16 onto the substrate and grounding the entire sheet at the periphery of the deposited layers.

FIG. 3 is an example of a schematic partial cross-section illustrating an implementation of the structure of the driving circuit and the associated display element of FIG. 2. A portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂, or can be configured differently, for example by changing the structure, the polarity, or the material.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable reflective layer 14 (or a movable electrode connected to a deformable layer 34) supported by the supports 18, and an interconnect 126 electrically connecting the movable reflective layer 14 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be, e.g., a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display. In some implementations, the optical stack 16 can include more or fewer layers. For example, in some implementations, the optical stack 16 can include one or more insulating or dielectric layers covering one or more conductive layers or a combined conductive/absorptive layer.

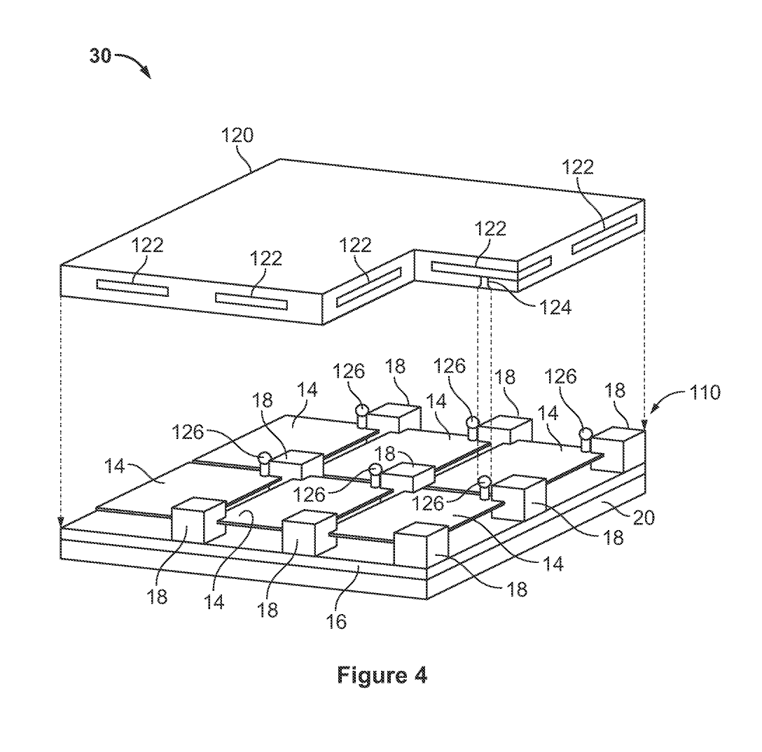

FIG. 4 is an example of a schematic exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, a movable reflective layer 14, and interconnects 126. The backplate 120 can include backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The reflective layers 14 can be separate from one another and can have, e.g., a square or rectangular shape. The movable reflective layers 14 can be arranged in a matrix form such that each of the movable reflective layers 14 can form part of a display element. In the implementation illustrated in FIG. 4, the movable reflective layers 14 are supported by the supports 18 at four corners.

Each of the interconnects 126 of the display array assembly 110 serves to electrically couple a respective one of the movable reflective layers 14 to one or more backplate components 122 (e.g., transistors S and/or other circuit elements). In the illustrated implementation, the interconnects 126 of the display array assembly 110 extend from the movable reflective layers 14, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend from the backplate 120 toward the movable reflective layers 14 so as to contact and thereby electrically connect to the movable reflective layers 14.

Electromechanical Display with Seal Anchor Structures

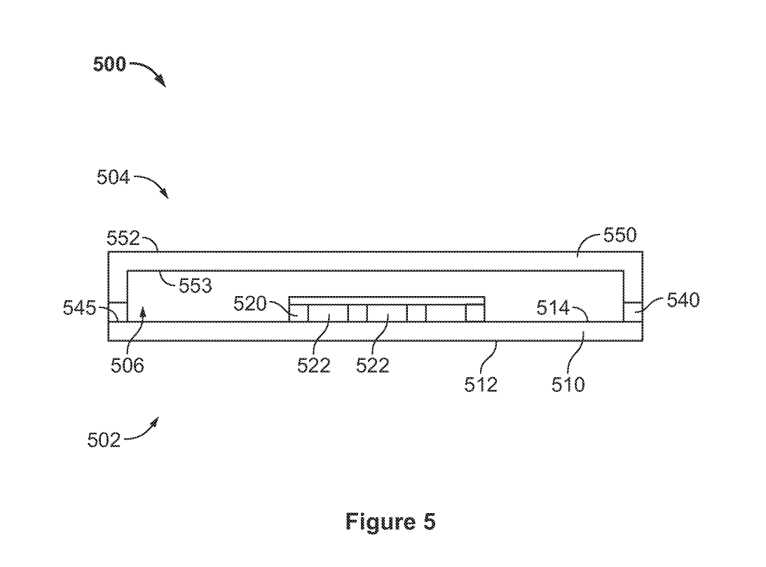

FIG. 5 shows an example of a cross-section of an electromechanical display package. The packaged electronic device 500 includes a substrate 510, an array 520 of interferometric modulators 522, a seal 540, and a backplate 550. The device 500 includes a bottom side 502 and a top side 504. The substrate 510 includes a lower surface 512 and an upper surface 514. On the upper surface 514 of the substrate the interferometric modulator array 520 is formed. In the illustrated implementation, the substrate 510 and the backplate 550 are joined by a seal 540, such that the interferometric modulator array 520 is encapsulated by the substrate 510, backplate 550, and the seal 540. This forms a cavity 506 between the backplate 550 and the substrate 510.

The substrate 510 can be any substrate on which an interferometric modulator 522 is formable. Such substances include, but are not limited to, glass, silica, alumina, plastic, and transparent polymers. In some implementations, the device 500 displays an image viewable from the lower side 502, and accordingly, the substrate 510 is substantially transparent or translucent. The term “array glass” also may be used to describe the substrate 510.

The backplate 550 also may be referred to herein as a “cap,” “backplane,” or “backglass.” These terms are not intended to limit the position of the backplate 550 within the device 500, or the orientation of the device 500 itself. In some implementations, the backplate 550 protects the array 520 from damage. Consequently, in some implementations, the backplate 550 protects the array 520 from contact with foreign objects and/or other components in an apparatus including the array 520, for example. Furthermore, in some implementations, the backplate 550 protects the array 520 from other environmental conditions, for example, humidity, moisture, dust, changes in ambient pressure, and the like.

In implementations in which the device 500 displays an image viewable from the top side 504, the backplate 550 is substantially transparent and/or translucent. In some other implementations, the backplate 550 is not substantially transparent and/or translucent. In some implementations, the backplate 550 is made from a material that does not produce or outgas a volatile compound, for example, hydrocarbons, acids, amines, and the like. In some implementations, the backplate 550 is substantially impermeable to liquid water and/or water vapor. In some implementations, the backplate 550 is substantially impermeable to air and/or other gases. Suitable materials for the backplate 550 include, for example, metals, steel, stainless steel, brass, titanium, magnesium, aluminum, polymer resins, epoxies, polyamides, polyalkenes, polyesters, polysulfones, polystyrene, polyurethanes, polyacrylates, parylene, ceramics, glass, silica, alumina, and blends, copolymers, alloys, composites, and/or combinations thereof. Examples of suitable composite materials include composite films available from Vitex Systems (San Jose, Calif.). In some implementations, the backplate 550 further includes a reinforcement, for example, fibers and/or a fabric, for example, glass, metal, carbon, boron, carbon nanotubes, and the like.

In some implementations, the backplate 550 is substantially rigid. In some other implementations, the backplate 550 is flexible, for example, foil or film. In some implementations, the backplate 550 is deformed in a predetermined configuration before and/or during assembly of the packaged device 500.

With continuing reference to FIG. 5, the backplate 550 includes an inner surface 553 and an outer surface 552. In some implementations, the inner surface 553 and/or outer surface 552 of the backplate 550 further include one or more additional structures, for example, a structural, protective, mechanical, and/or optical film or films.

In the implementation illustrated in FIG. 5, the backplate 550 is substantially planar. In some other implementations, the inner surface 553 of the backplate 550 may be recessed. A backplate with this configuration may be referred to as a “recessed cap” herein. Other implementations of a packaged device 500 may include a curved or bowed backplate 550. In some implementations, the backplate 550 is pre-formed into a curved configuration. In some other implementations, the curved shape of the backplate 550 is formed by bending or deforming a substantially flat precursor during assembly of the packaged device 500. For example, in some implementations, an array 520 of interferometric modulators is formed on a substrate 510 as described above. A seal material, for example, a UV curable epoxy, is applied to the periphery of a substantially planar backplate 550, which is wider and/or longer than the substrate 510. The backplate 550 is deformed, for example, by compression, to the desired size, and positioned on the substrate 510. The epoxy is cured, for example, using UV radiation to form the seal 540.

In some implementations, the gap or headspace between the inner surface 553 of the backplate and the array 520 is about 10 μm. In some implementations, the gap is from about 30 μm to about 100 μm, for example, about 40 μm, 50 μm, 60 μm, 70 μm, 80 μm, or 90 μm. In some implementations the gap can be greater than about 100 μm, for example, about 300 μm, about 0.5 mm, about 1 mm, or greater. In some implementations, the gap or headspace between the inner surface 553 of the backplate and the array 520 is not constant.

In some implementations, the seal 540 can be formed by applying a sealant to the substrate 510 and contacting the backplate 550 to the sealant. The seal 540 can be a hermetic or non-hermetic seal. The sealant may include conventional epoxy-based adhesives or any sealant composition depending upon the particular application. In some implementations, the sealant is a UV curable epoxy. In some implementations, the epoxy is XNR-5570-B1 from Nagase ChemteX Corporation (Osaka, Japan). In some implementations, the seal 540 is formed in a seal area 545. The seal area 545 may circumscribe the perimeter of the substrate 510. In some implementations, the seal can 540 circumscribe the array 520.

The packaging process may be accomplished in a vacuum, pressure between a vacuum up to and including ambient pressure, or pressure higher than ambient pressure. The packaging process also may be accomplished in an environment of varied and controlled high or low pressure during the sealing process. There may be advantages to packaging the interferometric modulator array 500 in a completely dry environment, but it is not necessary. Similarly, the packaging environment may be of an inert gas at ambient conditions. Packaging at ambient conditions allows for a lower cost process and more potential for versatility in equipment choice because the device may be transported through ambient conditions without affecting the operation of the device.

Generally, it is desirable to minimize the permeation of water vapor into the package structure and thus control the environment inside the package structure 500 and hermetically seal it to ensure that the environment remains constant. When the humidity within the package exceeds a level beyond which surface tension from the moisture becomes higher than the restoration force of a movable element (not shown) in the interferometric modulator 522, the movable element may become permanently stuck to the surface.

In some implementations, a desiccant may be used to control moisture resident within the package structure 500. However, the need for a desiccant can be reduced or eliminated with the implementation of a seal 540 that is hermetic to prevent moisture from traveling from the atmosphere into the cavity of the package structure 906.

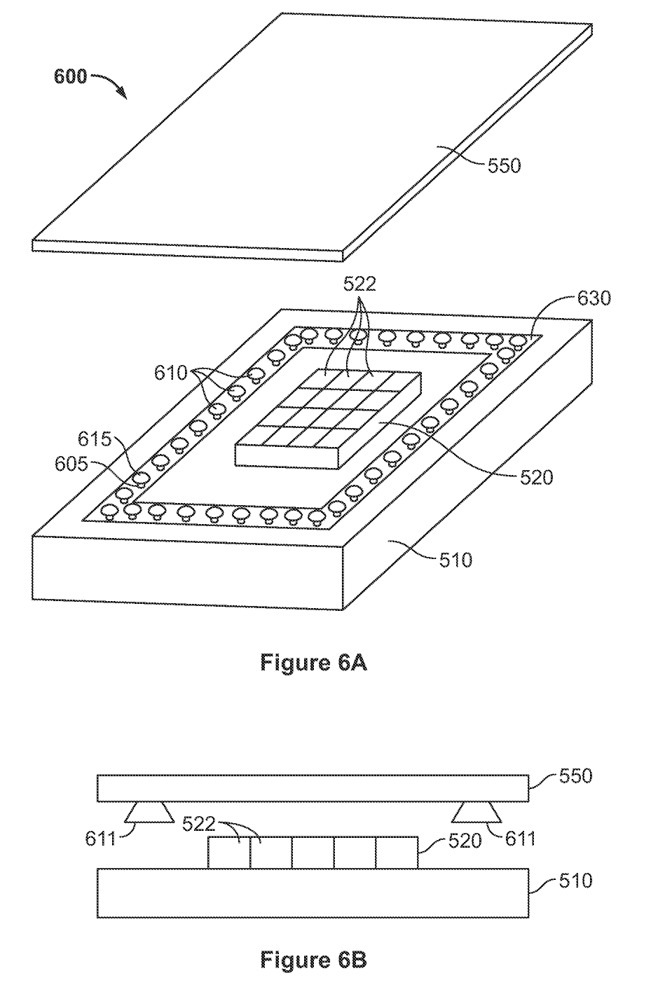

FIG. 6A is an example of a schematic exploded perspective view of an electromechanical display package having raised anchor structures. The device 600 includes a substrate 510 having an array 520 of interferometric modulators 522 formed thereon. The array 520 is surrounded by a seal area 630. In the example illustrated in FIG. 6A, the seal area 630 is the same shape as the substrate 510 and has a uniform width. However, in some implementations, the seal area 630 may be any closed shape and may have a varying width. In some implementations, the seal area 630 may not form a continuous path about the substrate 510 and/or the array 520. In some implementations, the seal area 630 has a width in the range of about 0.1-5 mm, for example, about 1.35 mm.

In the example illustrated in FIG. 6A, the array 520 does not cover the entire area within the perimeter of the seal area 630. However, the array 520 may cover the entire area or a majority of the area within the perimeter of the seal area 630. Although not illustrated to improve figure clarity the array 520 can include a mechanical layer anchored over an optical stack. The array may further include posts and interconnects for electrically connecting the array 520 to the backplate 550.

Continuing with FIG. 6A, the seal area 630 includes raised anchor structures 610. The raised anchor structures 610 will be described in further detail later. In the illustrated implementation, the raised anchor structures 610 are roughly mushroom-shaped. In some implementations, the raised anchor structures include a post 605 disposed on the substrate 510 and a cap 610 disposed on the post 605. The raised anchor structures 610 can have a height greater than or equal to the height of the array 520. In some implementations, the raised anchor structures 610 can have a height less than the height of the array. In some implementations, raised anchor structures 610 may be roughly frustoconical in shape.

In some implementations, the substrate 510 is secured to a backplate 550 by disposing a sealant over the seal area 630 and the raised anchor structures 610 and contacting the backplate 550 to the sealant. However, the sealant may be applied to the backplate 550 and/or the substrate 510. The sealant can be applied using various means depending upon the particular application, for example, by printing. The sealant may be provided over an area less than the width of the seal area 630 width to allow for the sealant to spread to the total width of the seal area 630. In some implementations, the sealant is not disposed over the entire seal area 630 or over all of the raised anchor structures 610.

FIG. 6B is an example of a cross-sectional view of an electromechanical display package having raised anchor structures. The illustrated example is similar to FIG. 6A but different in that the raised anchor structures 611 are disposed on the backplate 550 rather than on the substrate 510. Such an implementation may be useful, for example, in applications where the backplate is subjected to some process or treatment which reduces the adhesion of a sealant onto the backplate. In some implantations, the raised anchor structures 611 may be roughly frustoconical in shape, as shown in FIG. 6B. It is understood that FIGS. 6A and 6B are schematic and may not be drawn to scale, as raised anchor structures 611 may be very small relative to other features shown, such as the backplate 550. Furthermore, in some implementations, the backplate 550 in FIGS. 6A and 6B may be a recessed backplate in order to provide a recessed area for the array 520.

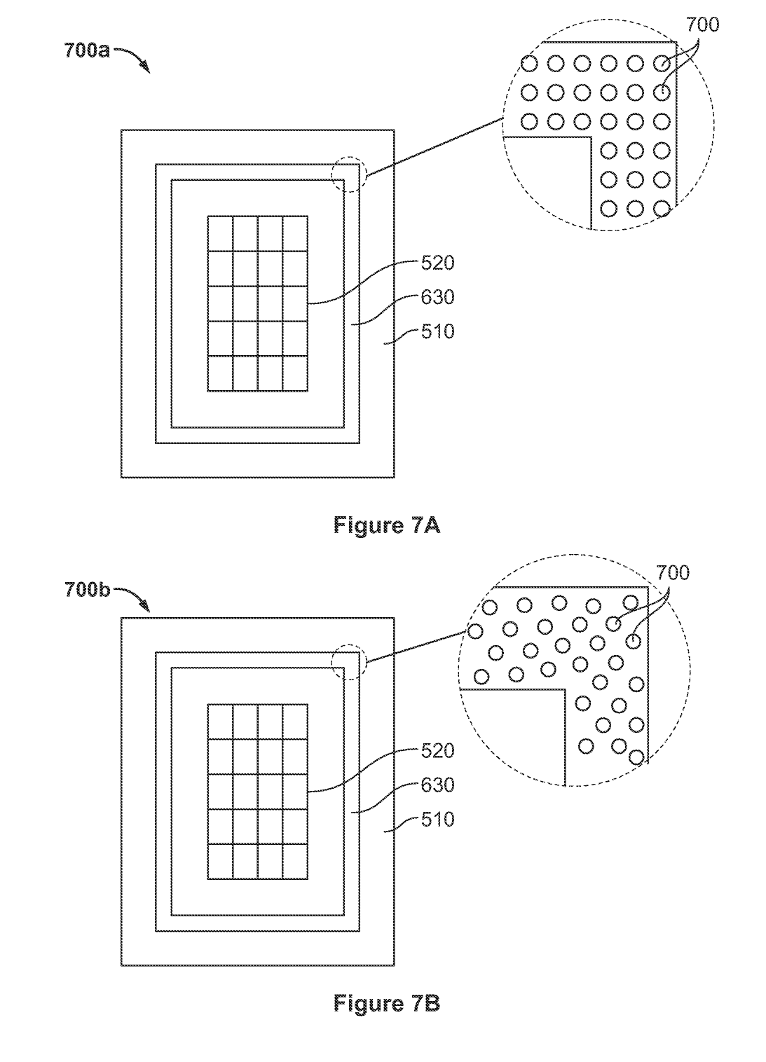

FIGS. 7A and 7B show example top views of optical MEMS display device having raised anchor structures. Devices 700a and 700b include a substrate 510 having an array of interferometric modulators 520 formed thereon. In the implementations illustrated in FIGS. 7A and 7B, the seal area 630 circumscribes the array 520. A plurality of raised anchor structures 700 can be located in the seal area 630. In some implementations, the seal area 630 includes between about 3,000-9,000 anchor structures per square millimeter, for example, about 6,000 anchor structures per square millimeter. The raised anchor structures 700 can be arranged in regular patterns as in FIG. 7A or 7B or in a random pattern (not shown) within the seal area 630. In general, a regular pattern involves a simpler and easier to implement manufacturing process.

FIG. 7B shows an example of a top view of an optical MEMS display device having raised anchor structures 700 arranged in roughly parallel, staggered rows having centers that are spaced from one another by about the dimension (such as a diameter) of one anchor. As illustrated, the spacing between the staggered rows is roughly equal to the length of one dimension of the raised anchor structures 700, such as one anchor diameter. While the spacing is illustrated as roughly regular, it is understood that the spacing may also be irregular. In some implementations, the precise location of at least some anchor structures 700 is randomly offset from a generally regular pattern. Such a layout can help prevent the formation of micro-channels in the seal. For example, a straight line drawn orthogonal to the anchor area will contact at least one anchor. Thus, the arrangement of the anchor structures can aid in the prevention of micro-channels in the seal which can act as a pathway for moisture ingress.

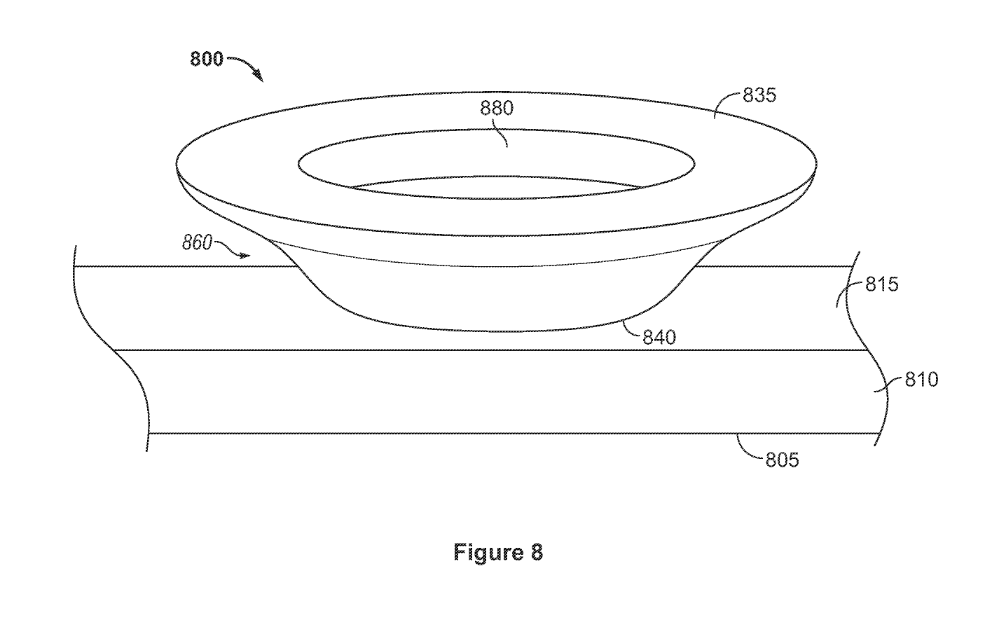

FIG. 8 is an example of a perspective view of a raised anchor structure. The example illustrated shows a raised anchor structure 800 disposed over a dielectric layer 810. The dielectric layer 810 includes a top surface 815 and a bottom surface 805. In some implementations, the bottom surface of the dielectric layer 805 can be disposed on a substrate (not shown) or disposed on one or more additional other layers. In some implementations, the raised anchor structure 800 is disposed directly on the substrate.

In the illustrated implementation, the raised anchor structure 800 is roughly shaped as a truncated cone, such that the raised anchor structure 800 is roughly shaped as a trapezoid when viewed from the side and as roughly circular when viewed from above. However in some implementations, the raised anchor structure 800 is shaped as a cube, frustum (formed, for example, by cutting the top of a cone or a pyramid), trapezoidal prism, pyramid, cylinder, or any other suitable three-dimensional shape. The cone shaped design can allow for sealant to more easily flow into the receiving space because air can escape easier along the continuous curved feature than from, for example, an isolated cavity. Further, the curved structures may have greater mechanical strength than straight structures. Large, straight overhangs may be more susceptible to crack propagation and applied forces while smaller overhangs may allow air to escape easier and are less likely to break off from applied forces. Small curved structures may also have more overhang area per raised structure, thus maximizing the adhesive contact area.

The raised anchor structure 800 includes a lower surface 840 disposed on the top surface of the dielectric layer 815 and an upper surface 835. As illustrated, the lower surface 840 can have a diameter less than the diameter of the upper surface 835. In some implementations, the lower surface 840 can have a diameter in the in the range of about 1-10 μm, for example, about 4 μm, and the upper surface 835 can have a diameter in the in the range of about 1-10 μm, for example, about 6 μm. By implementing a bowl-like shape, the upper surface 835 can extend out over the lower surface 840 and form an overhang 860. The overhang 860 can act as a receiving space for sealant. Sealant can be deposited over and around the seal area and can flow into and under overhang 860.

Raised anchor structures including receiving spaces for sealant can act as mechanical hooks to which the sealant can adhere to. The hooks can increase adhesive surface area and increasing overall seal strength, even in areas where the adhesive bonding strength with the surfaces is less than ideal. In some implementations, the raised anchor structure 800 includes a depression 880 in the upper surface 835. Such a depression 880 can further increase the adhesive surface area and further increase overall bond strength.

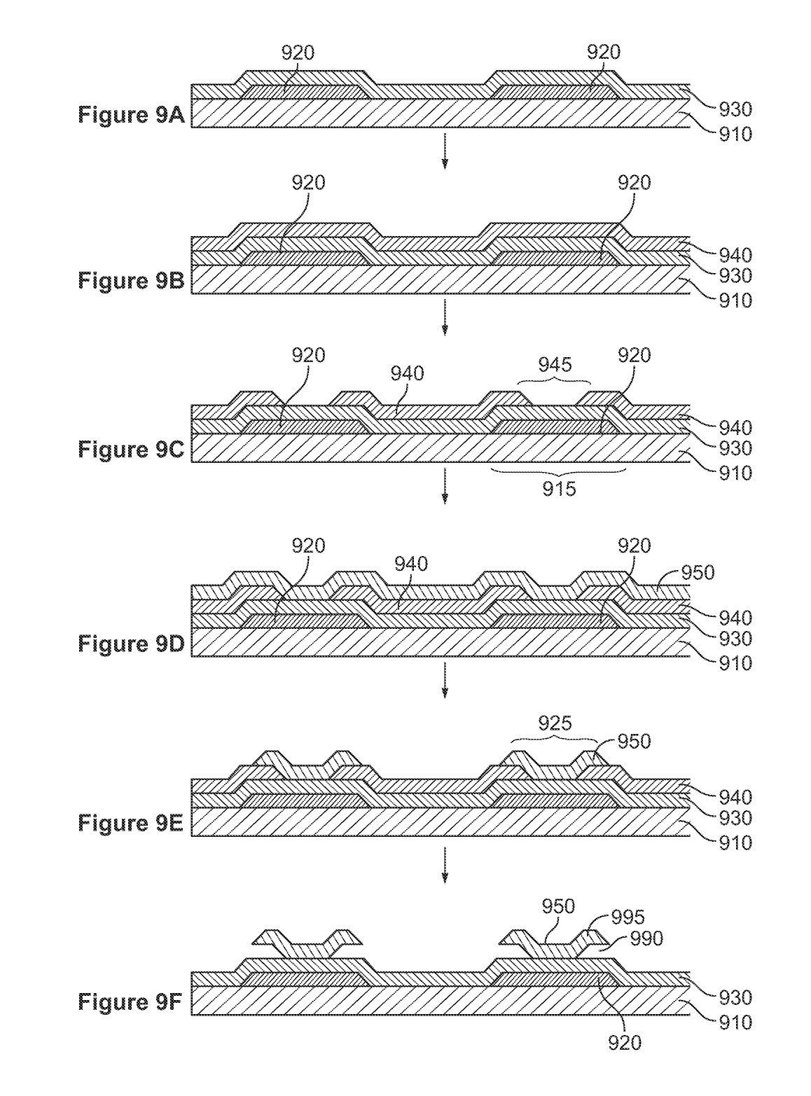

FIGS. 9A-9F show examples of cross-section schematic illustrations of various stages in a method of making raised anchor structures in a seal area. The raised anchor structures can be formed by a variety of techniques known to those of skill in the art including photolithography, dry etching and/or wet etching and/or plasma etching. The dimensions of the raised structures can vary in height and width depending on the desired anchor properties and the dimensions of the display package and/or the dimensions of the display area. As used herein, and as will be understood by a person/one having ordinary skill in the art, the term “patterned” or “patterning” refers to masking as well as etching processes. The following is an example process of forming a raised anchor structure according to some implementations.

In FIG. 9A, the example process begins by depositing a first dielectric layer 910 over a substrate (not shown). The first dielectric layer 910 can include, for example, silicon oxide (SiOₓ), silicon oxynitride (SiON), tetraethyl orthosilicate (TEOS), and/or other suitable materials depending upon the particular application. In some implementations, the first dielectric layer 910, includes a silicon dioxide (SiO₂) layer having a thickness in the range of about 500-2,000 nm, for example, about 1,000 nm. However, the first dielectric layer 910 can be any suitable thicknesses depending on the desired height of the raised anchor structure and the dimensions of the interferometer modulators.

Continuing with FIG. 9A, a metal routing layer 920 can be formed over the first dielectric layer 910. The metal routing layer 920 may be a dummy routing layer. The metal routing layer 920 can simplify the manufacturing process by forming a pattern upon which the raised anchor structures may be formed over. For example, the metal routing layer 920 can be deposited when other similar routing layers are deposited in forming the MEMS or IMOD device. In some implementations, the metal routing layer 920 can be formed during the same process that forms an optical stack layer of an IMOD device.

The metal routing layer 920 can include alloys such as aluminum silicon (AlSi), molybdenum-chromium (MoCr) or any other routing composition depending upon the particular application. The routing layer 920 may be patterned to result in a area on which the raised anchor structures can be built. The routing layer may also transmit electrical signals. In some implementations, the routing layer 920 includes a MoCr layer having a thickness in the range of about 100-1,000 nm, for example, about 500 nm. However, the routing layer 920 can have a variety of thicknesses depending on the desired shape and height of the raised anchor structure. The etching process to remove the MoCr can include chlorine (Cl₂) and/or oxygen (O₂).

Continuing with FIG. 9A, a second dielectric layer can be deposited 930 over the first dielectric layer 910 and the metal routing layer 920. The second dielectric layer 930 may include the same materials as the first dielectric layer 910. In some implementations, the second dielectric layer 930 includes a SiO₂ layer having a thickness in the range of about 100-1,000 nm, for example, about 500 nm. However, the second dielectric layer 930 can be any suitable thicknesses depending on the desired shape and height of the raised anchor structure. The portions of the second dielectric layer 930 disposed over the metal routing layer 920 can form a portion of the base of a raised anchor structure.

In FIG. 9B, the process continues by depositing a sacrificial layer 940 over the second dielectric layer 930. In some implementations, a plurality of sacrificial layers can be provided over the second dielectric layer 930 so as to increase the overall thickness of the sacrificial layer 940. The sacrificial layer 940 can include any sacrificial composition, for example, a xenon difluoride (XeF₂)-etchable material such as molybdenum (Mo) or amorphous silicon (a-Si). Deposition of the sacrificial material can be carried out using deposition techniques such as physical vapor deposition (PVD, e.g., sputtering), plasma-enhanced chemical vapor deposition (PECVD), thermal chemical vapor deposition (thermal CVD), or spin-coating. In some implementations, the sacrificial layer 940 has a thickness in the range of about 100-4,000 nm, for example, about 800 nm. However, the sacrificial layer 940 can be of any suitable of thicknesses depending on the desired shape and size of the overhang to be formed.

In FIG. 9C, the process continues by patterning the sacrificial layer 940. Accordingly, portions of the sacrificial layer 940 above a base area 915 may be removed. The sacrificial layer 940 may be removed, for example, by dry chemical etching, wet etching, plasma etching, and/or any other suitable etching technique. The patterning may result in post areas 945 roughly above the center of the metal routing layer 920. In some implementations, the sacrificial layer 940 includes a Mo layer and the etching process to remove the Mo can include Cl₂ and/or O₂.

In FIG. 9D, the process continues by depositing a third dielectric layer 950 over the sacrificial layer 940 and the second dielectric layer 930. The third dielectric layer 950 may include the same materials as the first dielectric layer 910 and/or the second dielectric layer 930. In some implementations, the third dielectric layer 950 includes a SiO₂ having a thickness in the range of about 100-1,000 nm, for example, about 500 nm. However, the second dielectric layer 930 can be any suitable thicknesses depending on the desired shape and height of the raised anchor structure.

In FIG. 9E, the process continues by patterning the third dielectric layer 950 such that the third dielectric layer 950 remains in an area roughly above the routing layer 920. The remaining third dielectric layer 950 can form a cap area 925 roughly disposed over a base area 915. A portion of the third dielectric layer 950 may remain disposed over the sacrificial layer 940. When the sacrificial layer is later removed, such portions of the third dielectric layer 950 that remained on the sacrificial layer 940 can form overhangs. As such, the amount of third dielectric layer 950 disposed on the sacrificial layer 940 can be adjusted depending on the desired dimensions of the overhang. In some implementations, the overhang can extend about in the range of about 0.1-2 μm, for example about 200 nm, over the sacrificial layer 940.

In FIG. 9F, the process continues by removing the sacrificial layer 940. In some implementations, the sacrificial layer 940 is removed by exposing the sacrificial layer 940 to vapors derived from solid XeF2. The sacrificial layer 940 can be exposed for a period of time that is effective to remove the material. Other selective etching methods can be used, for example, wet etching and/or plasma etching. Removing the sacrificial layer 940 can result in the formation of an overhang 990. The portion of the third dielectric layer deposited on the sacrificial layer 940 can act as a wing or hook 995.

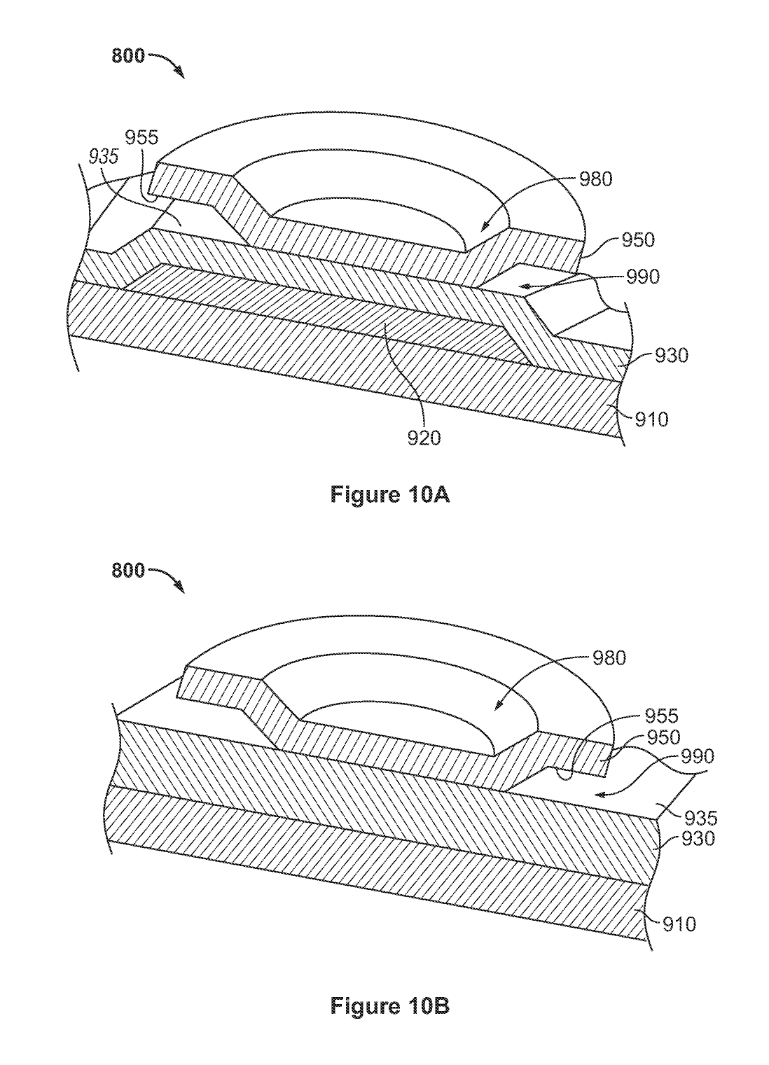

FIGS. 10A and 10B show examples of partial cut away perspective views of raised anchor structures. As shown in FIG. 10A, the raised anchor structure can include a routing layer 920 disposed over a first dielectric layer 910. A second dielectric layer 930 can be disposed over the routing layer 920 and first dielectric layer 910. A third dielectric layer 950 can be disposed over portions of the second dielectric layer 930. An overhang 990 can be formed in between the top surface of the second dielectric layer 935 and the bottom surface of the third dielectric layer 955 by removing a sacrificial layer (not shown) originally deposited in the receiving space in a process similar to the process above. An overhang 990 can be formed by the portions of the third dielectric layer 950 which extend over the second dielectric layer 930. FIG. 10B shows an implementation of the raised anchor structure 800 that is not built over a routing layer 920.

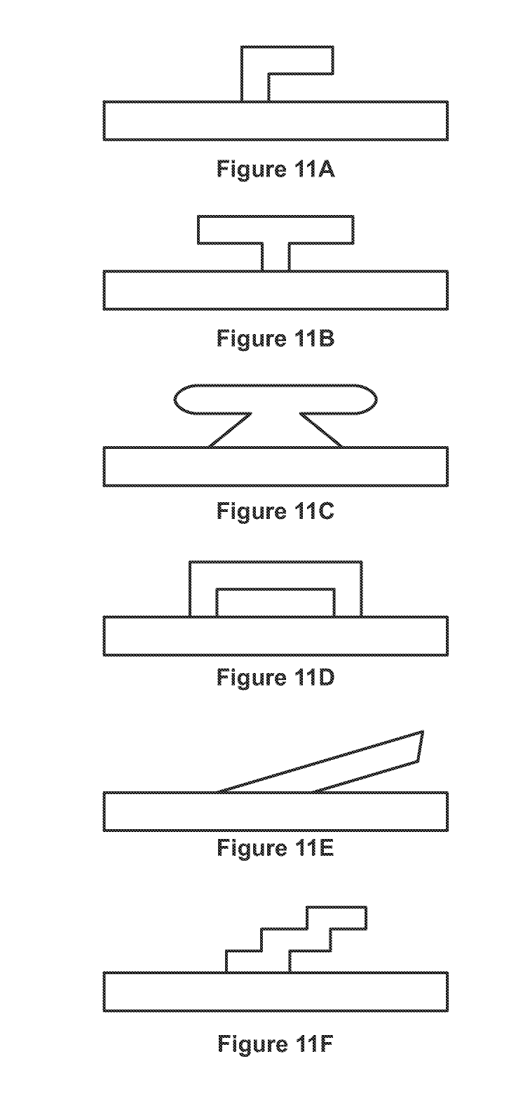

FIGS. 11A-11F show examples of cross-section schematic illustrations of raised anchor structures. FIG. 11A shows an example of a raised anchor structure having an “L” shape structure and one overhang. FIG. 11B shows an example of a raised anchor structure having a “T” shape structure and two overhangs. FIG. 11C shows an example similar to FIG. 11B including two overhangs. FIG. 11D shows an example of a raised anchor structure having a “U” shaped structure. The empty area under the “U” can receive sealant. In some implementations, the “U” can also include at least one overhang section extending out from at least a portion of the “U” structure, roughly parallel to the substrate. FIGS. 11E and 11F show examples of raised anchor structures having one overhang section. The structures can be formed with similar techniques as described above. One skilled in the art can form such structures using lithography techniques and can create numerous raised structures which include any number of overhangs.

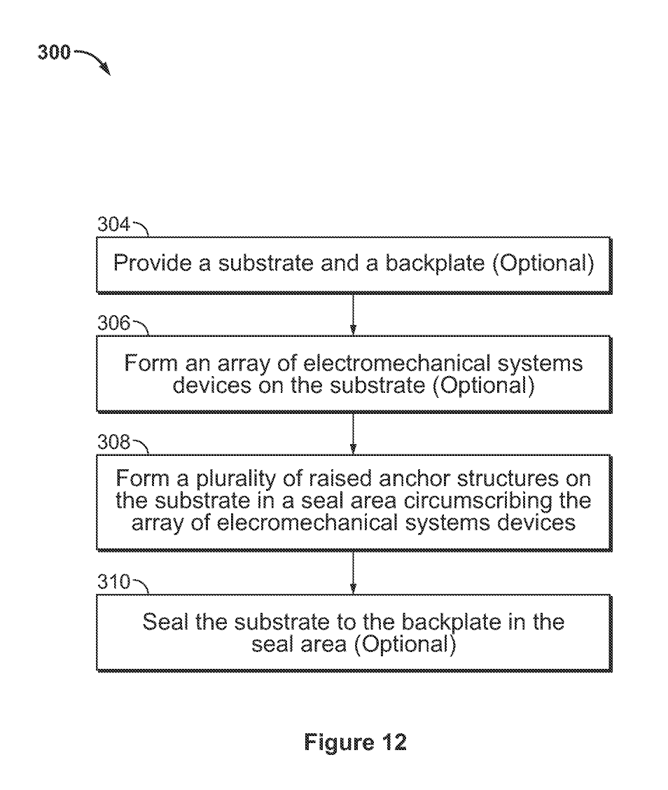

FIG. 12 shows an example process of manufacturing an electromechanical systems device package with raised anchor structures. As shown in block 304 the process 300 can begin by optionally providing a substrate and a backplate. The process 300 can continue in block 306 by optionally forming an array of electromechanical systems devices on the substrate. The process 300 continues in block 308 by forming a plurality of raised anchor structures on the substrate in a seal area circumscribing the array of electromechanical systems devices. The process 300 can continue in block 310 by optionally sealing the substrate to the backplate in the seal area.

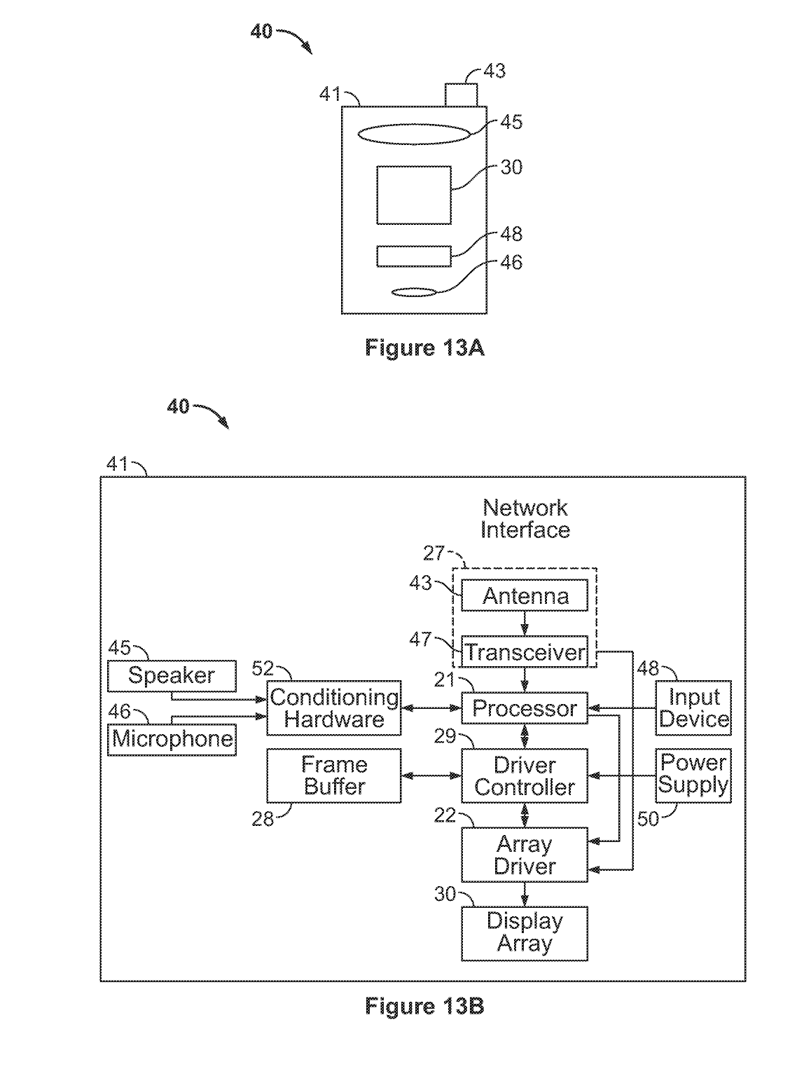

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

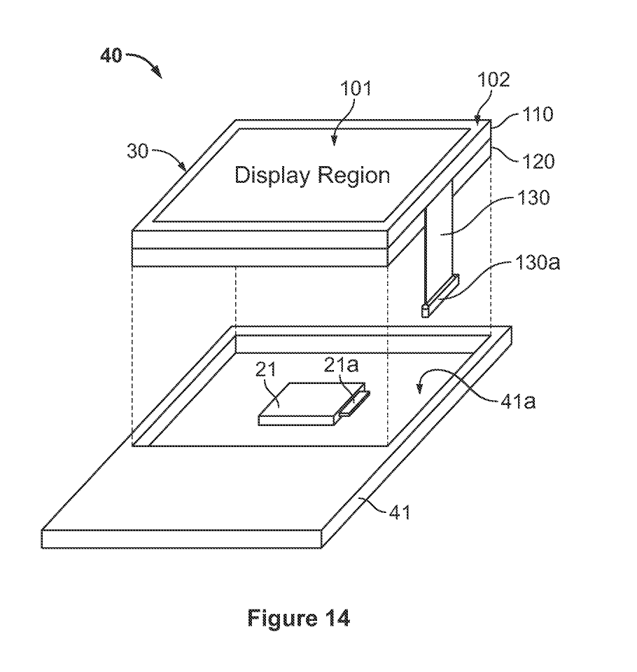

FIG. 14 is an example of a schematic exploded perspective view of the electronic device 40 of FIGS. 13A and 13B according to some implementations. The illustrated electronic device 40 includes a housing 41 that has a recess 41a for a display array 30. The electronic device 40 also includes a processor 21 on the bottom of the recess 41a of the housing 41. The processor 21 can include a connector 21a for data communication with the display array 30. The electronic device 40 also can include other components, at least a portion of which is inside the housing 41. The other components can include, but are not limited to, a networking interface, a driver controller, an input device, a power supply, conditioning hardware, a frame buffer, a speaker, and a microphone, as described earlier in connection with FIG. 13B.

The display array 30 can include a display array assembly 110, a backplate 120, and a flexible electrical cable 130. The display array assembly 110 and the backplate 120 can be attached to each other, using, for example, a sealant.

The display array assembly 110 can include a display region 101 and a peripheral region 102. The peripheral region 102 surrounds the display region 101 when viewed from above the display array assembly 110. The display array assembly 110 also includes an array of display elements positioned and oriented to display images through the display region 101. The display elements can be arranged in a matrix form. In some implementations, each of the display elements can be an interferometric modulator. Also, in some implementations, the term “display element” may be referred to as a “pixel.”

The backplate 120 may cover substantially the entire back surface of the display array assembly 110. The backplate 120 can be formed from, for example, glass, a polymeric material, a metallic material, a ceramic material, a semiconductor material, or a combination of two or more of the foregoing materials, in addition to other similar materials. The backplate 120 can include one or more layers of the same or different materials. The backplate 120 also can include various components at least partially embedded therein or mounted thereon. Examples of such components include, but are not limited to, a driver controller, array drivers (for example, a data driver and a scan driver), routing lines (for example, data lines and gate lines), switching circuits, processors (for example, an image data processing processor) and interconnects.

The flexible electrical cable 130 serves to provide data communication channels between the display array 30 and other components (for example, the processor 21) of the electronic device 40. The flexible electrical cable 130 can extend from one or more components of the display array assembly 110, or from the backplate 120. The flexible electrical cable 130 can include a plurality of conductive wires extending parallel to one another, and a connector 130a that can be connected to the connector 21a of the processor 21 or any other component of the electronic device 40.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electronic device, comprising:
a substrate having an array of electromechanical devices and a seal area;
a plurality of raised anchor structures positioned in the seal area of the substrate;
a backplate; and
a sealant disposed in the seal area between the substrate and the backplate.

2. The electronic device of claim 1, wherein the seal area circumscribes the array of electromechanical devices.

3. The electronic device of claim 1, wherein the raised anchor structures include at least one receiving space configured to receive the sealant.

4. The electronic device of claim 2, wherein the receiving space is formed by an overhang.

5. The electronic device of claim 1, wherein receiving space is formed by a circular rounded top.

6. The electronic device of claim 1, wherein the seal area includes between about 3,300 to 8,300 raised anchor structures per square millimeter.

7. The electronic device of claim 1, wherein the raised anchor structures have a diameter between about 4-6 microns.

8. The electronic device of claim 1, wherein the electronic device includes a routing layer and the raised anchor structures are built over the routing layer.

9. The electronic device of claim 1, wherein the raised anchor structures include a dielectric material.

10. The electronic device of claim 9, wherein the dielectric material includes silicon dioxide.

11. The electronic device of claim 1, wherein the raised anchor structures include a truncated cone having a top surface including a depression.

12. The electronic device of claim 1, wherein the substrate is a transparent substrate.

13. The electronic device of claim 1, wherein the electromechanical devices are interferometric modulator display devices.

14. The electronic device of claim 1, wherein the electronic device is a wireless telephone.

15. The electronic device of claim 1, further comprising:
a display;
a processor that is configured to communicate with the display, the processor being configured to process image data; and
a memory device that is configured to communicate with the processor.

16. The electronic device as recited in claim 15, further comprising:
a driver circuit configured to send at least one signal to the display.

17. The electronic device as recited in claim 16, further comprising:
a controller configured to send at least a portion of the image data to the driver circuit.

18. The electronic device as recited in claim 15, further comprising:
an image source module configured to send the image data to the processor.

19. The electronic device as recited in claim 18, wherein the image source module includes at least one of a receiver, transceiver, and transmitter.

20. The electronic device as recited in claim 15, further comprising:
an input device configured to receive input data and to communicate the input data to the processor.

21. A display package comprising:
a substrate having an array of electromechanical devices, a backplate, and a sealant disposed between the substrate and the backplate; and
a means for anchoring the sealant to the substrate, wherein the anchoring means is formed on the substrate and circumscribes the array.

22. The display package of claim 21, wherein the means for anchoring includes providing surfaces to bind the sealant to the substrate.

23. The display package of claim 21, wherein the means for anchoring is a raised post and cap structure.

24. The display package of claim 21, wherein the means for anchoring includes at least one overhang.

25. The display package of claim 21, wherein the means for anchoring is configured to receive the sealant below an overhang.

26. The display package of claim 21, wherein the electromechanical devices are interferometric modulator devices.

27. A method of fabricating an electromechanical systems device package, comprising:
providing a substrate and a backplate;
forming an array of electromechanical systems devices on the substrate; and
forming a plurality of raised anchor structures on the substrate in a seal area circumscribing the array of electromechanical systems devices.

28. The method of claim 27, further including sealing the substrate to the backplate in the seal area.

29. The method of claim 27, wherein the raised anchor structures include at least one overhang.

30. The method of claim 28, wherein the overhang is formed by removing a sacrificial layer.

31. The method of claim 27, wherein forming the plurality of raised anchor structures is performed simultaneously with forming the array of electromechanical systems devices.

32. The method of claim 27, wherein the substrate is hermetically sealed to the backplate.

33. The method of claim 27, wherein the electromechanical systems devices are interferometric modulator devices.
